(19) United States
(12) Patent Application Publication
(10) Pub. No.: US 2022/0258288 A1
(43) Pub. Date: Aug. 18, 2022

(54) SOLDER ALLOY, SOLDER POWDER, SOLDER PASTE, AND SOLDER JOINT OBTAINED USING THESE

(71) Applicant: SENJU METAL INDUSTRY CO., LTD., Adachi-ku, Tokyo (JP)

(72) Inventors: Hiroyoshi KAWASAKI, Tokyo (JP); Osamu MUNEKATA, Tokyo (JP); Masato SHIRATORI, Tokyo (JP)

(21) Appl. No.: 17/614,195

(22) PCT Filed: Jan. 31, 2020
(86) PCT No.: PCT/JP2020/003714

§ 371 Date: Nov. 24, 2021

(30) Foreign Application Priority Data
May 27, 2019 (JP) 2019-098944

(51) Int. Cl. B23K 35/26; C22C 13/00; B23K 35/02

(52) U.S. Cl. CPC B23K 35/262; B23K 35/025; C22C 13/00

(57) ABSTRACT

A solder alloy, a solder powder and the like, which suppresses change in a solder paste over time and has excellent wettability, a small temperature difference between the liquidus temperature and the solidus temperature, and excellent mechanical properties, and exhibits a high joint strength, are provided. The solder alloy has an alloy composition containing 0.55 to 0.75 mass % of Cu, 0.0350 to 0.0600 mass % of Ni, 0.0035 to 0.0200 mass % of Ge, and 25 to 300 mass ppm of As, at least either one of 0 to 3000 mass ppm of Sb, 0 to 10000 mass ppm of Bi, and 0 to 5100 mass ppm of Pb, and a balance of Sn, and satisfies Expressions (1) to (3) below.

275≤2As+Sb+Bi+Pb (1)

0.01≤(2As+Sb)/(Bi+Pb)≤10.00 (2)

10.83≤Cu/Ni≤18.57 (3)

In Expressions (1) to (3) shown above, Cu, Ni, As, Sb, Bi, and Pb each represent an amount (mass ppm) in the alloy composition.

### TECHNICAL FIELD

The present invention relates to a solder alloy, a solder powder, a solder paste, and a solder joint using these.

### BACKGROUND ART

A mounting substrate in which electronic components are mounted on a printed substrate is used for various electronic devices. A mounting substrate in which a plurality of substrates are stacked to realize a full range of functions is used in addition to a single-layer substrate. Examples of electrical connection between substrates or mounting electronic components on a substrate include a method for connecting the substrates through surface mounting or a method for inserting terminals into through holes for mounting. Examples of such mounting processes on a printed substrate include flow soldering, reflow soldering, and manual soldering.

Among these, a method for inserting terminals into through holes for mounting is employed to mount electronic components having a certain size from the viewpoint of connection strength or the like. Usual flow soldering is employed for the mounting process. Flow soldering is a method of soldering by applying a jet surface of a solder bath on a connection surface side of a printed substrate.

Examples of solder alloys used for such flow soldering include an Sn—Cu—Ni solder alloy as disclosed in Patent Document 1. It is disclosed that, in such a solder alloy, a solid solution of the solder alloy itself is strengthened due to Cu added to Sn, and generation of intermetallic compounds such as Cu₆Sn₅ or Cu₃Sn in the solder alloy is suppressed due to Ni added thereto. In addition, it is disclosed in the literature that a high melting point of such an intermetallic compound inhibits the fluidity of molten metal at the time of melting an alloy.

Incidentally, in recent years, electronic devices having solder joints such as a central processing unit (CPU) have been required to be miniaturized and have high performance. Along with this, it is necessary to reduce the size of electrodes of printed substrates and electronic devices. Since an electronic device is connected to a printed substrate through an electrode, the size of a solder joint connecting the two decreases along with the miniaturization of the electrode. In the case of the connection through such a fine electrode, it is difficult to say that flow soldering is an appropriate mounting method.

In general, reflow soldering using a solder paste is employed in order to connect an electronic device to a printed substrate through such a fine electrode. Reflow soldering is a soldering method in which paste is collectively applied to electrodes on a printed substrate through a metal mask and the printed substrate on which an electronic device is mounted is introduced into a reflow furnace. Here, in a case where the solder paste is purchased, not all of the solder paste may be usually used up at the time of one printing. Therefore, it is necessary for the solder paste to maintain its appropriate initial viscosity at manufacture so as not to impair printing performance.

For example, a solder alloy containing Sn, one or more selected from the group consisting of Ag, Bi, Sb, Zn, In, and Cu, and a predetermined amount of As to suppress change in a solder paste over time is disclosed in Patent Document 2. The literature shows a result in which the viscosity at 25° C. after 2 weeks is less than 140% compared to the initial viscosity at production. In addition, it is also disclosed in the literature that the solder alloy contains less than 10 ppm of Ni as unavoidable impurities.

### CITATION LIST

### Patent Literature

### [Patent Document 1]

Japanese Unexamined Patent Application, First Publication No. 2000-197988

### [Patent Document 2]

Japanese Unexamined Patent Application, First Publication No. 2015-98052

### SUMMARY OF INVENTION

### Technical Problem

In the invention disclosed in Patent Document 1, the alloy is mainly designed for use in flow soldering and focuses on the fluidity of a molten solder or the tensile strength of solder alloys. Since the objects to be joined through flow soldering are relatively large electronic components as described above, it is difficult to employ this for connection of electronic devices having fine electrodes as described above. In addition, in a solder joint joined with a solder alloy, the joining interface should not break. However, in the solder alloys disclosed in Patent Document 1, only the mechanical properties of the solder alloys themselves have been paid attention to. The solder alloys disclosed in Patent Document 1 contain Ni to suppress production of compounds of Sn and Cu. However, Ni is consumed to improve the mechanical strength of the solder alloys themselves as described above, and it is uncertain whether the strength at the joining interface of the solder joint is sufficiently improved. Further studies are required to join the fine electrodes of recent years without problems.

In addition, as described above, the invention disclosed in Patent Document 2 is a solder alloy that can selectively contain 6 kinds of elements in addition to Sn and As. In addition, the literature shows results of deterioration in meltability due to the high amount of As.

Here, it is thought that the meltability evaluated in Patent Document 2 corresponds to the wettability of a molten solder. The appearance of a molten material is observed with a microscope to evaluate the meltability disclosed in the literature according to the presence or absence of solder powder that cannot be completely melted. This is because it is unlikely that a solder powder that cannot be completely melted will remain if the wettability of the molten solder is high.

In general, it is necessary to use a highly active flux to improve the wettability of a molten solder. In a flux disclosed in Patent Document 2, it is thought that a highly active flux may be used to suppress the deterioration in wettability due to As. However, if a highly active flux is used, a reaction between a solder alloy and an activator proceeds, whereby the viscosity of paste increases. In addition, in view of the disclosure of Patent Document 2, it is necessary to increase the amount of As to suppress increase of the viscosity. In order for the solder paste disclosed in Patent Document 2 to exhibit a lower viscosity increase rate and excellent wettability, it is necessary to continuously increase the activity of the flux and the amount of As, which causes a vicious cycle.

Recently, stable performance has been required to be maintained for a solder paste for a long period of time regardless of a usage environment or a storage environment, and higher wettability is also required due to miniaturization of solder joints. When trying to meet recent demands using the solder paste disclosed in Patent Document 2, a vicious cycle is unavoidable as described above.

Furthermore, it is necessary to improve mechanical properties or the like of solder joints in order to join fine electrodes. Depending on elements, when the contents thereof increase, the liquidus temperature increases, the difference between the liquidus temperature and the solidus temperature increases, and segregation occurs during solidification to form a non-uniform alloy structure. In a case where a solder alloy has such an alloy structure, mechanical properties such as tensile strength deteriorate and a solder joint easily breaks due to external stress. These problems have become significant along with the recent miniaturization of electrodes.

An object of the present invention is to provide a solder alloy which suppresses change in a solder paste over time and has excellent wettability, a small temperature difference between the liquidus temperature and the solidus temperature, and excellent mechanical properties, and exhibits a high joint strength, a solder powder, a solder paste, and a solder joint using these.

### Solution to Problem

When suppressing changes in a paste over time and having improved and excellent wettability at the same time, it is necessary to avoid a vicious cycle due to use of a flux having high activity and increase in the amount of As. In addition, it is necessary for a solder joint to have a high joint strength. The present inventors have focused on an alloy composition of a solder alloy and have conducted extensive studies to improve the joint strength of the solder joint and to achieve both suppression of change in a paste over time and excellent wettability regardless of the type of flux.

First, the present inventors have focused on suppression of production of compounds of Sn and Cu in a solder alloy and suppression of deterioration in wettability due to oxidation of a molten solder as in the related art, and an alloy obtained by adding a trace amount of Ge to an Sn—Cu—Ni solder alloy is regarded as a basic composition. In this basic composition, the range of the amount of Cu is limited to suppress thermal damage to an electronic device due to an increase in the liquidus temperature and improve the strength of a solder joint. In addition, the range of the amount of Ni is also limited from the viewpoints of exhibiting a growth inhibition effect of Sn—Cu compounds due to Ni not only in the solder alloy but also at a joining interface and suppressing a large amount of precipitation in the vicinity of the joining interface of Sn—Cu—Ni compounds.

Furthermore, the present inventors have examined a solder powder containing As in an Sn—Cu—Ni—Ge solder alloy. Moreover, they have investigated the amount of As while focusing on the reason for suppressing the change in a solder paste over time in a case of using such a solder powder.

It is thought that the reason why the viscosity of a solder paste increases over time is because a solder powder reacts with a flux. Moreover, if results of Example 4 are compared with those of Comparative Example 2 in Table 1 of Patent Document 2, the results show that having an As content of higher than 100 mass ppm lowers a rate of viscosity increase. In view of this, in a case where the effect of suppressing change in a paste over time (hereinafter, appropriately referred to as a “thickening suppression effect”) is focused on, it is considered that the amount of As may be further increased. In the case where the amount of As is increased, the thickening suppression effect is slightly increased along with the amount of As. However, the thickening suppression effect obtained does not correspond to the increase of the amount of As. It is thought that this is because the amount of As concentrated on the surface of a solder alloy is limited and the amount of As inside the solder alloy in which little thickening suppression effect is exhibited even if a predetermined amount or more of As is incorporated increases. In addition, it has been confirmed that, if the amount of As is too high, the wettability of a solder alloy deteriorates.

Moreover, the present inventors have postulated that it may be necessary to extend the range of the amount of As up to a range in which no thickening suppression effect is exhibited due to a small amount of As in the related art and then to add elements in which the thickening suppression effect is exhibited in addition to As and have investigated various elements. As a result, they have coincidentally found that Sb, Bi, and Pb have the same effect as that of As. Although the reason for this is unclear, it is presumed to be as follows.

The thickening suppression effect is exhibited by suppressing a reaction with a flux. Examples of elements having a low reactivity with a flux include elements having a low ionization potential. In general, the ionization of an alloy is considered in terms of an ionization potential in an alloy composition, that is, a standard electrode potential. For example, an Sn—Ag alloy containing Ag which is nobler than Sn ionizes less readily than Sn. For this reason, since an alloy having an element nobler than Sn ionizes less readily, it is inferred that the thickening suppression effect of a solder paste therewith would be excellent.

Here, although Bi, Sb, Zn, and In in addition to Sn, Ag, and Cu are listed as equivalent elements in Patent Document 2, In and Zn are base elements compared to Sn in terms of the ionization potential. That is, Patent Document 2 discloses that a thickening suppression effect can be obtained even if an element baser than Sn is added. For this reason, it is thought that the same or a better thickening suppression effect compared to that of the solder alloy disclosed in Patent Document 2 could be obtained from a solder alloy containing an element selected according to the ionization potential. In addition, if the amount of As increases, the wettability deteriorates as described above.

The present inventors have investigated in detail Bi and Pb exhibiting a thickening suppression effect. Since Bi and Pb decreases the liquidus temperature of solder alloys, in a case where the heating temperature of the solder alloys is constant, the wettability of the solder alloys is improved. However, depending on the contents thereof, the solidus temperature significantly decreases. Therefore, ΔT which is a temperature difference between the liquidus temperature and the solidus temperature becomes too large. If ΔT is too large, segregation occurs during solidification, which leads to deterioration in mechanical properties such as mechanical strength. It has been found that strict management is necessary when the phenomenon that ΔT becomes large significantly appears in a case where Bi and Pb are added at the same time.

Furthermore, the present inventors have re-investigated the contents of Bi and Pb to improve the wettability of solder alloys. ΔT became large as the contents of these elements increase. Therefore, the present inventors have selected Sb as an element of which the ionization potential is nobler than Sn and which improves the wettability of solder alloys and have defined an allowable range of the amount of Sb, and then have investigated in detail a relation between the contents of As, Bi, Pb, and Sb when Sb is included. As a result, they have coincidentally found that, in a case where the amounts of all of the above-described constituent elements are within a predetermined range and the contents of As, Bi, Pb, and Sb satisfy a predetermined relational expression, growth of Sn—Cu compounds at a joining interface is inhibited, formation of Sn—Cu—Ni compounds in the vicinity of a joining interface is inhibited, and there is no practical problem in all of an excellent thickening suppression effect, wettability, and narrowing of ΔT, and have completed the present invention.

The present invention obtained from these findings is as follows.

(1) A solder alloy which has an alloy composition containing 0.55 to 0.75 mass % of Cu, 0.0350 to 0.0600 mass % of Ni, 0.0035 to 0.0200 mass % of Ge, and 25 to 300 mass ppm of As, at least either one of 0 to 3000 mass ppm of Sb, 0 to 10000 mass ppm of Bi, and 0 to 5100 mass ppm of Pb, and a balance of Sn, and satisfies Expressions (1) to (3) below.

275≤2As+Sb+Bi+Pb (1)

0.01≤(2As+Sb)/(Bi+Pb)≤10.00 (2)

10.83≤Cu/Ni≤18.57 (3)

In Expressions (1) to (3) shown above, Cu, Ni, As, Sb, Bi, and Pb each represent an amount (mass ppm) in the alloy composition.

(2) The solder alloy according to above-described (1), in which the alloy composition further satisfies Expression (1a) below.

275≤2As+Sb+Bi+Pb≤25200 (1a)

In Expression (1a) shown above, As, Sb, Bi, and Pb each represent an amount (mass ppm) in the alloy composition.

(3) The solder alloy according to the above-described (1), in which the alloy composition further satisfies Expression (1b) below.

275≤2As+Sb+Bi+Pb≤5300 (1b)

In Expression (1b) shown above, As, Sb, Bi, and Pb each represent an amount (mass ppm) in the alloy composition.

(4) The solder alloy according to any one of the above-described (1) to (3), in which the alloy composition further satisfies Expression (2a) below.

0.31≤(2As+Sb)/(Bi+Pb)≤10.00 (2a)

In Expression (2a) shown above, As, Sb, Bi, and Pb each represent an amount (mass ppm) in the alloy composition.

(5) The solder alloy according to any one of the above-described (1) to (4), in which the alloy composition further contains 0 to 4 mass % of Ag.

(6) A solder powder formed of the solder alloy according to any one of the above-described (1) to (5).

(7) A solder paste composed of the solder powder according to the above-described (6) (which contains no solder powder other than the solder powder according to the above-described (6)).

(8) A solder joint composed of the solder alloy according to any one of the above-described (1) to (5) (which contains no solder alloy other than the solder alloy according to the one of the above-described (1) to (5)).

### DESCRIPTION OF EMBODIMENTS

The present invention will be described in more detail below. In the present specification, “ppm” relating to a solder alloy composition is “mass ppm” unless otherwise specified. “%” is “mass %” unless otherwise specified.

### 1. Alloy Composition

### (1) Cu: 0.55% to 0.75%

Cu is used in general solder alloys and is an element that improves the joint strength of solder joints. In addition, Cu is an element which is nobler than Sn, and when Cu coexists with As, the effect of suppressing thickening of As is promoted. In a case where the amount of Cu is less than 0.55%, the strength of solder joints is not improved. The lower limit of the amount of Cu is greater than or equal to 0.55%, preferably greater than 0.55%, and more preferably greater than or equal to 0.60%. On the other hand, if the amount of Cu is greater than 0.75%, melting points of solder alloys increase, which causes thermal damage on electronic components. The upper limit of the amount of Cu is less than or equal to 0.75%, preferably less than 0.75%, and more preferably less than or equal to 0.70%.

### (2) Ni: 0.0350% to 0.0600%

Ni is an element that inhibits the growth of intermetallic compounds such as Cu₃Sn or Cu₆Sn₅ at a joining interface. In a case where the amount of Ni is less than 0.0350%, these intermetallic compounds grow and the mechanical strength of solder joints deteriorates. The lower limit of the amount of Ni is greater than or equal to 0.0350%, preferably greater than 0.0350%, and more preferably greater than or equal to 0.0400%. On the other hand, if the amount of Ni is greater than 0.0600%, a large amount of Sn—Cu—Ni compounds is precipitated in the vicinity of a joining interface in a solder alloy, and the mechanical strength of solder joints deteriorates. The upper limit of the amount of Ni is less than or equal to 0.0600%, preferably less than 0.0600%, and more preferably less than or equal to 0.0550%.

### (3) Ge: 0.0035% to 0.0200%

Ge is an element that suppresses oxidation of solder alloys to prevent deterioration in wettability or discoloration of the solder alloys, and suppresses production of dross derived from Fe. In a case where the amount of Ge is less than 0.0035%, deterioration in wettability or discoloration of solder alloys occurs. The lower limit of the amount of Ge is greater than or equal to 0.0035%, preferably greater than or equal to 0.0040%, more preferably greater than or equal to 0.0050%, and still more preferably greater than or equal to 0.0080%. On the other hand, if the amount of Ge is greater than 0.0200%, the wettability deteriorates due to precipitation of a large amount of oxides on surfaces of solder alloys. Consequently, the mechanical strength of solder joints deteriorates. The upper limit of the amount of Ge is less than or equal to 0.0200%, preferably less than 0.0200%, more preferably less than or equal to 0.0150%, and particularly preferably less than or equal to 0.0120%.

### (4) As: 25 to 300 ppm

As is an element capable of suppressing change in viscosity of a solder paste over time. Since As has low reactivity with a flux and is an element nobler than Sn, it is inferred that As can exhibit a thickening suppression effect. If As is less than 25 ppm, the thickening suppression effect cannot be sufficiently exhibited. The lower limit of the amount of As is greater than or equal to 25 ppm, preferably greater than 25 ppm, more preferably greater than or equal to 50 ppm, and still more preferably greater than or equal to 100 ppm. On the other hand, if the amount of As is too high, the wettability of solder alloys deteriorates. The upper limit of the amount of As is less than or equal to 300 ppm, preferably less than 300 ppm, more preferably less than or equal to 250 ppm, still more preferably less than or equal to 200 ppm, and particularly preferably less than or equal to 150 ppm.

### (5) At Least One of 0 to 3000 ppm of Sb, 0 to 10000 ppm of Bi, and 0 to 5100 ppm of Pb

Sb is an element which has low reactivity with a flux and exhibits a thickening suppression effect. In a case where the solder alloy according to the present invention contains Sb, the lower limit of the amount of Sb is greater than or equal to 0 ppm, preferably greater than 0 ppm, more preferably greater than or equal to 25 ppm, still more preferably greater than or equal to 50 ppm, particularly preferably greater than or equal to 100 ppm, and most preferably greater than or equal to 200 ppm. On the other hand, if the amount of Sb is too high, the wettability deteriorates. Therefore, it is necessary to set the content thereof to a moderate level. The upper limit of the amount of Sb is less than or equal to 3000 ppm, preferably less than or equal to 1150 ppm, and more preferably less than or equal to 500 ppm.

Similarly to Sb, Bi and Pb are elements which have low reactivity with a flux and exhibit a thickening suppression effect. In addition, Bi and Pb lower the liquidus temperature of a solder alloy and reduce the viscosity of a molten solder, and therefore, are elements capable of suppressing deterioration in the wettability due to As.

If at least one element of Sb, Bi, and Pb is present, the deterioration in the wettability due to As can be suppressed. In a case where the solder alloy according to the present invention contains Bi, the lower limit of the amount of Bi is greater than or equal to 0 ppm, preferably greater than 0 ppm, more preferably greater than or equal to 25 ppm, still more preferably greater than or equal to 50 ppm, still more preferably greater than or equal to 75 ppm, particularly preferably greater than or equal to 100 ppm, and most preferably greater than or equal to 200 ppm. In a case where the solder alloy according to the present invention contains Pb, the lower limit of the amount of Pb is greater than or equal to 0 ppm, preferably greater than 0 ppm, more preferably greater than or equal to 25 ppm, still more preferably greater than or equal to 50 ppm, still more preferably greater than or equal to 75 ppm, particularly preferably greater than or equal to 100 ppm, and most preferably greater than or equal to 200 ppm.

On the other hand, if the contents of these elements are too high, the solidus temperature decreases significantly. Therefore, ΔT which is a temperature difference between the liquidus temperature and the solidus temperature becomes too large. If ΔT is too large, crystal phases which have a low amount of Bi or Pb and have a high melting point are precipitated in the process of coagulation of a molten solder, and therefore, Bi or Pb in a liquid phase is concentrated. Thereafter, if the temperature of the molten solder further decreases, crystal phases which have a high concentration of Bi or Pb and have a low melting point become segregated. For this reason, the mechanical strength or the like of a solder alloy deteriorates, and the reliability deteriorates. Since crystal phases having a high Bi concentration are hard and brittle, the reliability significantly deteriorates if the crystal phases become segregated in the solder alloy.

From such viewpoints, in a case where the solder alloy according to the present invention contains Bi, the upper limit of the amount of Bi is less than or equal to 10000 ppm, preferably less than or equal to 1000 ppm, more preferably less than or equal to 600 ppm, and still more preferably less than or equal to 500 ppm. In a case where the solder alloy according to the present invention contains Pb, the upper limit of the amount of Pb is less than or equal to 5100 ppm, preferably less than or equal to 5000 ppm, more preferably less than or equal to 1000 ppm, still more preferably less than or equal to 850 ppm, and particularly preferably less than or equal to 500 ppm.

### (6) Expression (1)

The solder alloy according to the present invention needs to satisfy Expression (1) below.

275≤2As+Sb+Bi+Pb (1)

In Expression (1) shown above, As, Sb, Bi, and Pb each represent an amount (ppm) in the alloy composition.

As, Sb, Bi, and Pb are all elements exhibiting a thickening suppression effect. The total content thereof needs to be greater than or equal to 275. The reason why the amount of As is doubled in Expression (1) is because As has a better thickening suppression effect than that of Sb, Bi, or Pb.

If Expression (1) is less than 275, the thickening suppression effect is not sufficiently exhibited. The lower limit of Expression (1) is greater than or equal to 275, preferably greater than or equal to 350, and more preferably greater than or equal to 1200. On the other hand, the upper limit of Expression (1) is not particularly limited from the viewpoint of the thickening suppression effect, but is preferably less than or equal to 25200, more preferably less than or equal to 10200, still more preferably less than or equal to 5300, and particularly preferably less than or equal to 3800 from the viewpoint of setting ΔT within a suitable range.

In Expressions (1a) and (1b) below, the upper limit and the lower limit are appropriately selected from the above-described preferred aspects.

275≤2As+Sb+Bi+Pb≤25200 (1a)

275≤2As+Sb+Bi+Pb≤5300 (1b)

In Expressions (1a) and (1b) shown above, As, Sb, Bi, and Pb each represent an amount (mass ppm) in the alloy composition.

### (7) Expression (2)

The solder alloy according to the present invention needs to satisfy Expression (2) below.

0.01≤(2As+Sb)/(Bi+Pb)≤10.00 (2)

In Expression (2) shown above, As, Sb, Bi, and Pb each represent an amount (mass ppm) in the alloy composition.

If the contents of As and Sb are high, wettability of a solder alloy deteriorates. On the other hand, although Bi and Pb suppress the deterioration in the wettability due to the inclusion of As, if the contents of Bi and Pb are too high, ΔT increases. Therefore, strict management is required. In particular, ΔT easily increases in the alloy composition in which Bi and Pb are simultaneously included. In view of these, if the contents of Bi and Pb are increased to excessively improve the wettability, ΔT becomes large. On the other hand, if the amount of As or Sb is increased to improve the thickening suppression effect, the wettability deteriorates. In the present invention, in a case where the elements are divided into a group of As and Sb and a group of Bi and Pb and the total amount of both groups is within a predetermined appropriate range, all of the thickening suppression effect, narrowing of ΔT, and the wettability are simultaneously satisfied.

If Expression (2) is less than 0.01, the total amount of Bi and Pb becomes relatively larger than the total amount of As and Sb, and therefore, ΔT becomes large. The lower limit of Expression (2) is greater than or equal to 0.01, preferably greater than or equal to 0.02, more preferably greater than or equal to 0.41, still more preferably greater than or equal to 0.90, particularly preferably greater than or equal to 1.00, and most preferably greater than or equal to 1.40. On the other hand, if Expression (2) is greater than 10.00, the total amount of As and Sb becomes relatively larger than the total amount of Bi and Pb, and therefore, the wettability deteriorates. The upper limit of Expression (2) is less than or equal to 10.00, preferably less than or equal to 5.33, more preferably less than or equal to 4.50, still more preferably less than or equal to 4.18, still more preferably less than or equal to 2.67, and particularly preferably less than or equal to 2.30.

The denominator of Expression (2) is “Bi+Pb”, and if these elements are not included, Expression (2) is not satisfied. That is, the solder alloy according to the present invention always contains at least one of Bi and Pb. In the alloy composition in which Bi and Pb are not included, the wettability deteriorates as described above.

In Expression (2a) below, the upper limit and the lower limit are appropriately selected from the above-described preferred aspects.

0.31≤(2As+Sb)/(Bi+Pb)≤10.00 (2a)

In Expression (2a) shown above, Bi, and Pb each represent an amount (mass ppm) in the alloy composition.

### (8) Ag: 0% to 4%

Ag is an arbitrary element capable of forming Ag₃Sn at a crystal interface to improve the reliability of the solder alloy. In addition, Ag is an element whose ionization potential is nobler than Sn, and when Ag coexists with As, Pb, and Bi, the thickening suppression effects of these elements are promoted. Furthermore, since Ag is less than or equal to 4%, the increase in ΔT is sufficiently suppressed. The amount of Ag is preferably 0% to 4%, more preferably 0.5% to 3.5%, and still more preferably 1.0% to 3.0%.

### (9) Expression (3)

10.83≤Cu/Ni≤18.57 (3)

In Expression (3) described above, Cu and Ni each represent an amount (mass %) in the alloy composition.

In the solder alloy according to the present invention, it is desirable that the amounts of the constituent elements be within the ranges described above and Cu and Ni satisfy Expression (3). The constituent elements in the solder alloy do not independently function, but can exhibit various effects only when the amounts of the constituent elements are all within predetermined ranges. Since Cu and Ni have a relation of a whole solid solution in an equilibrium phase diagram, these greatly contribute to inhibition of growth of Sn—Cu compounds at a joining interface or inhibition of formation of Sn—Cu—Ni compounds. Accordingly, in the present invention, since the amounts of the constituent elements are within the above-described ranges and Cu and Ni satisfy a predetermined relation, the effect of the present invention can be more sufficiently exhibited.

Expression (3) is preferably 10.83 to 18.57 and more preferably 11.0 to 15.0.

### (10) Balance: Sn

The balance of the solder alloy according to the present invention is Sn. The solder alloy may contain unavoidable impurities in addition to the above-described elements. The inclusion of unavoidable impurities does not affect the above-described effects.

### 2. Solder Powder

The solder powder according to the present invention is used in a solder paste to be described below and is preferably a spherical powder. The spherical powder improves the fluidity of solder alloys. The solder powder according to the present invention preferably satisfies sizes (grain size distribution) satisfying Symbols 1 to 8 in the classification (Table 2) of the powder size in JIS Z 3284-1:2014. Sizes (grain size distribution) satisfying Symbols 4 to 8 are more preferable and sizes (grain size distribution) satisfying Symbols 5 to 8 are still more preferable. If the particle diameter satisfies these conditions, an increase in viscosity is suppressed because the surface area of a powder is not too large and aggregation of a fine powder is suppressed. For this reason, it is possible to perform soldering on finer parts.

The sphericity of a solder powder is preferably greater than or equal to 0.90, more preferably greater than or equal to 0.95, and most preferably greater than or equal to 0.99. In the present invention, the sphericity of a spherical powder is measured with a CNC image measurement system (Ultra Quick Vision ULTRA QV350-PRO Measurement Device manufactured by Mitutoyo Corporation) in which minimum zone center method (MZC method) is used. In the present invention, the sphericity represents deviation from a true sphere and is an arithmetic average value calculated when, for example, diameters of 500 balls are divided by major axes. As the value is closer to 1.00 which is the upper limit, the balls are closer to true spheres.

### 3. Solder Paste

The solder paste according to the present invention contains the above-described solder powder and a flux.

### (1) Component of Flux

A flux used in the solder paste is composed of any one or a combination of two or more of an organic acid, an amine, an amine hydrohalide, an organic halogen compound, a thixotropic agent, rosin, a solvent, a surfactant, a base agent, a polymer compound, a silane coupling agent, and a colorant.

Examples of organic acids include succinic acid, glutaric acid, adipic acid, pimelic acid, suberic acid, azelaic acid, sebacic acid, dimer acids, propionic acid, 2,2-bishydroxymethylpropionic acid, tartaric acid, malic acid, glycolic acid, diglycolic acid, thioglycolic acid, dithioglycolic acid, stearic acid, 12-hydroxystearic acid, palmitic acid, and oleic acid.

Examples of amines include ethylamine, triethylamine, ethylenediamine, triethylenetetramine, 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, a 2,4-diamino-6-[2′-methylimidazolyl-(1′)]-ethyl-s-triazine-isocyanuric acid adduct, a 2-phenylimidazole-isocyanuric acid adduct, 2-phenyl-4,5-dihydroxymethylimidazole, 2-phenyl-4-methyl-5-hydroxymethylimidazole, 2,3-dihydro-1H-pyrrolo[1,2-a]benzimidazole, 1-dodecyl-2-methyl-3-benzylimidazolium chloride, 2-methylimidazoline, 2-phenylimidazoline, 2,4-diamino-6-vinyl-s-triazine, a 2,4-diamino-6-vinyl-s-triazine-isocyanuric acid adduct, 2,4-diamino-6-methacryloyloxyethyl-s-triazine, an epoxy-imidazole adduct, 2-methylbenzimidazole, 2-octylbenzimidazole, 2-pentylbenzimidazole, 2-(1-ethylpentyl)-benzimidazole, 2-nonylbenzimidazole, 2-(4-thiazolyl)benzimidazole, benzimidazole, 2-(2′-hydroxy-5′-methylphenyl)benzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-5′-tert-octylphenyl) benzotriazole, 2,2′-methylenebis[6-(2H-benzotriazole-2-yl)-4-tert-octylphenol], 6-(2-benzotriazolyl)-4-tert-octyl-6′-tert-butyl-4′-methyl-2,2′-methylenebisphenol, 1,2,3-benzotriazole, 1-[N,N-bis(2-ethylhexyl) aminomethyl]benzotriazole, carboxybenzotriazole, 1-[N,N-bis(2-ethylhexyl) aminomethyl] methylbenzotriazole, 2,2′-[[(methyl-1H-benzotriazole-1-yl) methyl] imino]bisethanol, 1-(1′,2′-dicarboxyethyl)benzotriazole, 1-(2,3-dicarboxypropyl)benzotriazole, 1-[(2-ethylhexyl amino)methyl]benzotriazole, 2,6-bis[(1H-benzotriazole-1-yl) methyl]-4-methylphenol, 5-methylbenzotriazole, and 5-phenyltetrazole.

An amine hydrohalide is a compound obtained by reacting an amine and a hydrogen halide, and examples of amines include ethylamine, ethylenediamine, triethylamine, diphenylguanidine, ditolylguanidine, and methylimidazole, and 2-ethyl-4-methylimidazole, and examples of hydrogen halides include hydrides of chlorine, bromine, and iodine.

Examples of organic halogen compounds include trans-2,3-dibromo-2-butene-1,4-diol, triallyl isocyanurate hexabromide, 1-bromo-2-butanol, 1-bromo-2-propanol, 3-bromo-1-propanol, 3-bromo-1,2-propanediol, 1,4-dibromo-2-butanol, 1,3-dibromo-2-propanol, 2,3-dibromo-1-propanol, 2,3-dibromo-1,4-butanediol, and 2,3-dibromo-2-butene-1,4-diol.

Examples of thixotropic agents include a wax-based thixotropic agent an amide-based thixotropic agent, and a sorbitol-based thixotropic agent. Examples of wax-based thixotropic agents include hydrogenated castor oil. Examples of amide-based thixotropic agents include a monoamide-based thixotropic agent, a bisamide-based thixotropic agent, and a polyamide-based thixotropic agent, and specific examples thereof include lauric acid amide, palmitic acid amide, stearic acid amide, behenic acid amide, hydroxystearic acid amide, saturated fatty acid amides, oleic acid amide, erucic acid amide, unsaturated fatty acid amides, p-toluene methane amide, aromatic amide, methylenebisstearic acid amide, ethylenebislauric acid amide, ethylenebishydroxystearic acid amide, saturated fatty acid bisamide, methylenebisoleic acid amide, unsaturated fatty acid bisamide, m-xylylenebisstearic acid amide, aromatic bisamide, saturated fatty acid polyamide, unsaturated fatty acid polyamide, aromatic polyamide, substituted amides, methylol stearic acid amide, methylol amide, and fatty acid ester amides. Examples of sorbitol-based thixotropic agents include dibenzylidene-D-sorbitol and bis(4-methylbenzylidene)-D-sorbitol.

Examples of base agents include nonionic surfactants, weak cationic surfactants, and rosin.

Examples of nonionic surfactants include polyethylene glycol, a polyethylene glycol-polypropylene glycol copolymer, an aliphatic alcohol-polyoxyethylene adduct, an aromatic alcohol-polyoxyethylene adduct, and a polyhydric alcohol-polyoxyethylene adduct.

Examples of weak cationic surfactants include terminal diamine polyethylene glycol, a terminal diamine polyethylene glycol-polypropylene glycol copolymer, an aliphatic amine-polyoxyethylene adduct, an aromatic amine-polyoxyethylene adduct, and a polyvalent amine-polyoxyethylene adduct.

Examples of rosin include raw rosin such as gum rosin, wood rosin, and tall oil rosin, and derivatives obtained from the raw rosin. Examples of the derivatives include purified rosin, hydrogenated rosin, disproportionated rosin, polymerized rosin, an α,β-unsaturated carboxylic acid-modified product (such as acrylated rosin, maleated rosin, or fumarated rosin), a purified product, a hydride, and a disproportionated product of the polymerized rosin, and a purified product, a hydride, and a disproportionated product of α,β-unsaturated carboxylic acid-modified products, and two or more kinds thereof can be used. In addition to a rosin resin, the flux can further contain at least one resin selected from a terpene resin, a modified terpene resin, a terpene phenol resin, a modified terpene phenol resin, a styrene resin, a modified styrene resin, a xylene resin, and a modified xylene resin. An aromatic modified terpene resin, a hydrogenated terpene resin, a hydrogenated aromatic modified terpene resin, or the like can be used as a modified terpene resin. A hydrogenated terpene phenol resin or the like can be used as a modified terpene phenol resin. A styrene-acrylic resin, a styrene-maleic acid resin, or the like can be used as a modified styrene resin. Examples of modified xylene resins include a phenol-modified xylene resin, an alkylphenol-modified xylene resin, a phenol-modified resol-type xylene resin, a polyol-modified xylene resin, and a polyoxyethylene-added xylene resin.

Examples of solvents include water, an alcoholic solvent, a glycol ether-based solvent, and terpineols. Examples of alcoholic solvents include isopropyl alcohol, 1,2-butanediol, isobornyl cyclohexanol, 2,4-diethyl-1,5-pentanediol, 2,2-dimethyl-1,3-propanediol, 2,5-dimethyl-2,5-hexanediol, 2,5-dimethyl-3-hexyne-2,5-diol, 2,3-dimethyl-2,3-butanediol, 1,1,1-tris(hydroxymethyl)ethane, 2-ethyl-2-hydroxymethyl-1,3-propanediol, 2,2′-oxybis(methylene)bis(2-ethyl-1,3-propanediol), 2,2-bis(hydroxymethyl)-1,3-propanediol, 1,2,6-trihydroxyhexane, bis[2,2,2-tris(hydroxymethyl)ethyl]ether, 1-ethynyl-1-cyclohexanol, 1,4-cyclohexanediol, 1,4-cyclohexane dimethanol, erythritol, threitol, guaiacol glycerol ether, 3,6-dimethyl-4-octyne-3,6-diol, and 2,4,7,9-tetramethyl-5-decyne-4,7-diol. Examples of glycol ether-based solvents include diethylene glycol mono-2-ethylhexyl ether, ethylene glycol monophenyl ether, 2-methylpentane-2,4-diol, diethylene glycol monohexyl ether, diethylene glycol dibutyl ether, and triethylene glycol monobutyl ether.

Examples of surfactants include polyoxyalkylene acetylene glycols, polyoxyalkylene glyceryl ether, polyoxyalkylene alkyl ether, polyoxyalkylene ester, polyoxyalkylene alkylamine, and polyoxyalkylene alkylamide.

### (2) Amount of Flux

The amount of a flux based on the total mass of a solder paste is preferably 5% to 95% and more preferably 5% to 15%. Within these ranges, the thickening suppression effect due to a solder powder is sufficiently exhibited.

### (3) Method for Producing Solder Paste

The solder paste according to the present invention is produced through a method common in the art. First, well-known methods such as a dropping method in which a molten solder material is added dropwise to obtain particles, a spraying method in which the molten solder material is centrifugally sprayed, and a method in which a bulk solder material is pulverized can be employed for the production of a solder powder. In the dropping method or the spraying method, dropping or spraying is preferably performed in an inert atmosphere or a solvent in order to form particles. The above-described components can be heated and mixed with each other to prepare a flux, the above-described solder powder or, in some cases, a zirconium oxide powder can be introduced into the flux, and the mixture can be stirred and mixed to produce a solder paste.

### 4. Solder Joint

The solder joint according to the present invention is suitable for being used for connecting an IC chip to its substrate (interposer) in a semiconductor package or connecting a semiconductor package to a printed wiring board. Here, the “solder joint” means a connection portion of electrodes.

### 5. Others

The solder alloy according to the present invention may have a wire shape in addition to being used as a solder powder as described above.

A method for producing the solder joint according to the present invention may be performed according to a usual method.

A joining method in which the solder paste according to the present invention is used may be performed according to a usual method using, for example, a reflow method. The melting temperature of solder alloys in a case of performing flow soldering may be substantially about 20° C. higher than the liquidus temperature. In addition, in a case where the solder alloy according to the present invention is used for joining, it is preferable to consider the cooling rate during solidification from the viewpoint of miniaturization of the structure. For example, the solder joint is cooled at a cooling rate of higher than or equal to 2° C./s to 3° C./s. The other joining conditions can be appropriately adjusted according to the alloy composition of the solder alloy.

A low α-ray material can be used as a raw material of the solder alloy according to the present invention to produce a low α-ray alloy. If such a low α-ray alloy is used to form solder bumps around a memory, soft errors can be suppressed.

### EXAMPLES

The present invention will be described using the following examples, but is not limited to the following examples.

The solder alloys shown in the examples and the comparative examples in Tables 1 to 6 were used to evaluate 1. Inhibition of IMC Growth with respect to Cu, 2. Inhibition of Sn—Cu—Ni Formation in Bump, 3. Suppression of Thickening, 4. ΔT, and 5. Solder Wettability.

1. Inhibition of IMC Growth with Respect to Cu

A Bare-Cu plate coated with a liquid-like flux was dipped into a molten solder which was heated to 280° C. and had the alloy compositions shown in Tables 1 to 6 to manufacture a solder-plated Cu plate. This solder-plated Cu plate was heated for 300 hours on a hot plate heated to 150° C. In a cross-sectional SEM photograph of the solder alloy after cooling, arbitrary three sites within a range of 300 μm×300 μm were observed, and a maximum crystal grain size of an intermetallic compound was obtained.

In these examples, regarding the maximum crystal grain size, a largest crystal grain was visually selected among intermetallic compounds identified from an obtained image, and two parallel tangents were drawn on the selected crystal grain so as to maximize the interval therebetween which was regarded as the maximum crystal grain size.

In a case where the maximum value of the crystal grain size was less than 5 μm, it was evaluated as “◯”, and in a case where the maximum value thereof was greater than or equal to 5 μm, it was evaluated as “x”.

### 2. Inhibition of Sn—Cu—Ni Formation in Bump

A solder-plated Cu plate was manufactured in the same manner as in “1.” described above, arbitrary three sites at an interface between the Cu plate and the solder alloy were observed through the same method as in “1.” described above to check the presence or absence of Sn—Cu—Ni compounds in the solder alloy. In a case where the formation of Sn—Cu—Ni compounds was not observed in the vicinity of the interface of the solder alloy in all the sites, it was evaluated as “◯”, and in a case where the formation of Sn—Cu—Ni compounds was observed in at least one site, it was evaluated as “x”.

### 3. Suppression of Thickening

A flux adjusted to contain 42 parts by mass of rosin, 35 parts by mass of a glycol solvent, 8 parts by mass of a thixotropic agent, 10 parts by mass of an organic acid, 2 parts by mass of an amine, and 3 parts by mass of halogen was mixed with a solder powder which has the alloy compositions shown in Tables 1 to 6 and has sizes (grain size distribution) satisfying Symbol 4 in the classification (Table 2) of the powder size in JIS Z 3284-1:2014 to produce a solder paste. The mass ratio of a flux to a solder powder is flux:solder powder=11:89. Change in viscosity of each of the solder pastes over time were measured. In addition, the liquidus temperatures and the solidus temperatures of the solder powders were measured. Furthermore, the wettability was evaluated using the solder pastes immediately after production. The details are as follows.

The viscosity of each solder paste immediately after production was measured with PCU-205 manufactured by Malcolm Co., Ltd. at a rotational frequency of 10 rpm, 25° C., and in atmospheric air for 12 hours. If the viscosity after 12 hours was 1.2 times or less compared to the viscosity after the lapse of 30 minutes from the production of each solder paste, it was evaluated as “◯” which means that a sufficient thickening suppression effect was obtained. In a case where the viscosity after 12 hours exceeded 1.2 times, it was evaluated as “x”.

### 4. ΔT

Regarding the solder powder before being mixed with a flux, DSC was measured with EXSTAR DSC7020, model number, manufactured by SII NanoTechnology Inc. at an amount of sample of about 30 mg and a rate of temperature increase of 15° C./min to obtain a solidus temperature and a liquidus temperature. The obtained solidus temperature was subtracted from the obtained liquidus temperature to obtain ΔT. In a case where ΔT was less than or equal to 15° C., it was evaluated as “◯”. In a case where ΔT was greater than 15° C., it was evaluated as “x”.

### 5. Solder Wettability

A wet spreadability test was carried out in order of “1.” and “2.” below using solder balls which were made of the solder alloys shown in Table 1 and had a diameter of 0.3 mm. A substrate material used was a 1.2 mm glass epoxy substrate (FR-4).

1. Flux WF-6400 manufactured by Senju Metal Industry Co., Ltd. was printed on the above-described substrate, on which a 0.24 mm×16 mm slit-shaped Cu electrode was formed, by 0.24 mmφ×0.1 mm thick, solder balls were mounted thereon, the temperature was held in a temperature range of 220° C. or higher for 40 seconds, and reflowing was performed under the condition that the peak temperature was set to 245° C.

2. The wet-spreading area was measured with a stereomicroscope, and the wet spreadability of greater than or equal to 0.75 mm² was determined as “◯”. The wet spreadability of less than 0.75 mm² was determined as “x”.

Comprehensive Evaluation

In a case where all the above-described tests scored “◯”, it was evaluated as “◯”, and in a case where at least one test scored “x”, it was evaluated as “x”.

The evaluated results are shown in Tables 1 to 6.

TABLE 1

| | Alloy composition (mass % for Ag, Cu, Ge, and Ni | | | | | | | | | Expression | Expression |
|---|---|---|---|---|---|---|---|---|---|---|---|
| | and mass ppm for As, Sb, Bi, and Pb) | | | | | | | | | (1): 2As + | (2): (2As + |
| | Sn | Ag | Cu | Ge | Ni | As | Sb | Bi | Pb | Sb + Bi + Pb | Sb)/(Bi + Pb) |
| Example 1 | Bal. | — | 0.55 | 0.0080 | 0.0500 | 100 | 200 | 200 | 200 | 800 | 1.00 |
| Example 2 | Bal. | — | 0.60 | 0.0080 | 0.0500 | 100 | 200 | 200 | 200 | 800 | 1.00 |
| Example 3 | Bal. | — | 0.70 | 0.0080 | 0.0500 | 100 | 200 | 200 | 200 | 800 | 1.00 |
| Example 4 | Bal. | — | 0.75 | 0.0080 | 0.0500 | 100 | 200 | 200 | 200 | 800 | 1.00 |
| Example 5 | Bal. | — | 0.65 | 0.0150 | 0.0350 | 100 | 200 | 200 | 200 | 800 | 1.00 |
| Example 6 | Bal. | — | 0.65 | 0.0080 | 0.0550 | 100 | 200 | 200 | 200 | 800 | 1.00 |
| Example 7 | Bal. | — | 0.65 | 0.0080 | 0.0600 | 100 | 200 | 200 | 200 | 800 | 1.00 |
| Example 8 | Bal. | — | 0.65 | 0.0035 | 0.0500 | 100 | 200 | 200 | 200 | 800 | 1.00 |
| Example 9 | Bal. | — | 0.65 | 0.0050 | 0.0500 | 100 | 200 | 200 | 200 | 800 | 1.00 |
| Example 10 | Bal. | — | 0.65 | 0.0100 | 0.0500 | 100 | 200 | 200 | 200 | 800 | 1.00 |
| Example 11 | Bal. | — | 0.65 | 0.0120 | 0.0500 | 100 | 200 | 200 | 200 | 800 | 1.00 |
| Example 12 | Bal. | — | 0.65 | 0.0200 | 0.0500 | 100 | 200 | 200 | 200 | 800 | 1.00 |
| Example 13 | Bal. | — | 0.65 | 0.0040 | 0.0500 | 100 | 200 | 200 | 200 | 800 | 1.00 |
| Example 14 | Bal. | — | 0.65 | 0.0080 | 0.0500 | 100 | 200 | 200 | 200 | 800 | 1.00 |
| Example 15 | Bal. | — | 0.65 | 0.0080 | 0.0350 | 100 | 200 | 200 | 200 | 800 | 1.00 |
| Example 16 | Bal. | 1.0 | 0.65 | 0.0080 | 0.0500 | 100 | 200 | 200 | 200 | 800 | 1.00 |
| Example 17 | Bal. | 2.0 | 0.65 | 0.0080 | 0.0500 | 100 | 200 | 200 | 200 | 800 | 1.00 |
| Example 18 | Bal. | 3.0 | 0.65 | 0.0080 | 0.0500 | 100 | 200 | 200 | 200 | 800 | 1.00 |
| Example 19 | Bal. | 4.0 | 0.65 | 0.0080 | 0.0500 | 100 | 200 | 200 | 200 | 800 | 1.00 |
| Comparative | Bal. | — | 0.65 | 0.0050 | 0.0500 | 100 | 0 | 0 | 0 | 200 | — |
| Example 1 | | | | | | | | | | | |
| Comparative | Bal. | — | 0.65 | 0.0080 | — | 100 | 0 | 0 | 0 | 200 | — |
| Example 2 | | | | | | | | | | | |
| Comparative | Bal. | — | 0.65 | 0.0080 | 0.0500 | 100 | 0 | 0 | 0 | 200 | — |
| Example 3 | | | | | | | | | | | |
| Comparative | Bal. | — | 0.65 | 0.0080 | 0.0030 | 100 | 0 | 0 | 0 | 200 | — |
| Example 4 | | | | | | | | | | | |
| Comparative | Bal. | — | 0.65 | 0.0080 | 0.0100 | 100 | 0 | 0 | 0 | 200 | — |
| Example 5 | | | | | | | | | | | |
| Comparative | Bal. | — | 0.65 | 0.0080 | 0.1000 | 100 | 0 | 0 | 0 | 200 | — |
| Example 6 | | | | | | | | | | | |

| | | Inhibition | | | | | |
|---|---|---|---|---|---|---|---|
| | | of IMC | Inhibition | | | | |
| | | growth with | of Sn—Cu—Ni | | | | |
| | Expression | respect to | formation | Suppression | | Solder | Comprehensive |
| | (3): Cu/Ni | Cu | in bump | of thickening | ΔT | wettability | evaluation |
| Example 1 | 11.00 | ∘ | ∘ | ∘ | ∘ | ∘ | ∘ |
| Example 2 | 12.00 | ∘ | ∘ | ∘ | ∘ | ∘ | ∘ |
| Example 3 | 14.00 | ∘ | ∘ | ∘ | ∘ | ∘ | ∘ |
| Example 4 | 15.00 | ∘ | ∘ | ∘ | ∘ | ∘ | ∘ |
| Example 5 | 18.57 | ∘ | ∘ | ∘ | ∘ | ∘ | ∘ |
| Example 6 | 11.82 | ∘ | ∘ | ∘ | ∘ | ∘ | ∘ |
| Example 7 | 10.83 | ∘ | ∘ | ∘ | ∘ | ∘ | ∘ |
| Example 8 | 13.00 | ∘ | ∘ | ∘ | ∘ | ∘ | ∘ |
| Example 9 | 13.00 | ∘ | ∘ | ∘ | ∘ | ∘ | ∘ |
| Example 10 | 13.00 | ∘ | ∘ | ∘ | ∘ | ∘ | ∘ |
| Example 11 | 13.00 | ∘ | ∘ | ∘ | ∘ | ∘ | ∘ |
| Example 12 | 13.00 | ∘ | ∘ | ∘ | ∘ | ∘ | ∘ |
| Example 13 | 13.00 | ∘ | ∘ | ∘ | ∘ | ∘ | ∘ |
| Example 14 | 13.00 | ∘ | ∘ | ∘ | ∘ | ∘ | ∘ |
| Example 15 | 18.57 | ∘ | ∘ | ∘ | ∘ | ∘ | ∘ |
| Example 16 | 13.00 | ∘ | ∘ | ∘ | ∘ | ∘ | ∘ |
| Example 17 | 13.00 | ∘ | ∘ | ∘ | ∘ | ∘ | ∘ |
| Example 18 | 13.00 | ∘ | ∘ | ∘ | ∘ | ∘ | ∘ |
| Example 19 | 13.00 | ∘ | ∘ | ∘ | ∘ | ∘ | ∘ |
| Comparative | 13.00 | ∘ | ∘ | x | x | ∘ | x |
| Example 1 | | | | | | | |
| Comparative | — | x | ∘ | x | ∘ | ∘ | x |
| Example 2 | | | | | | | |
| Comparative | 13.00 | ∘ | ∘ | x | ∘ | ∘ | x |
| Example 3 | | | | | | | |
| Comparative | 216.67 | x | ∘ | x | ∘ | ∘ | x |
| Example 4 | | | | | | | |
| Comparative | 65.00 | x | ∘ | x | ∘ | ∘ | x |
| Example 5 | | | | | | | |
| Comparative | 6.50 | ∘ | x | x | ∘ | ∘ | x |
| Example 6 | | | | | | | |

The underlines indicate that the numerical values are out of the ranges of the present invention.

TABLE 2

| | Alloy composition (mass % for Ag, Cu, Ge, and Ni | | | | | | | | | Expression | Expression |
|---|---|---|---|---|---|---|---|---|---|---|---|
| | and mass ppm for As, Sb, Bi, and Pb) | | | | | | | | | (1): 2As + | (2): (2As + |
| | Sn | Ag | Cu | Ge | Ni | As | Sb | Bi | Pb | Sb + Bi + Pb | Sb)/(Bi + Pb) |
| Example 20 | Bal. | — | 0.65 | 0.0100 | 0.0500 | 100 | 25 | 25 | 25 | 275 | 4.50 |
| Example 21 | Bal. | — | 0.65 | 0.0100 | 0.0500 | 100 | 50 | 25 | 0 | 275 | 10.00 |
| Example 22 | Bal. | — | 0.65 | 0.0100 | 0.0500 | 100 | 0 | 75 | 0 | 275 | 2.67 |
| Example 23 | Bal. | — | 0.65 | 0.0100 | 0.0500 | 100 | 0 | 0 | 75 | 275 | 2.67 |
| Example 24 | Bal. | — | 0.65 | 0.0100 | 0.0350 | 100 | 50 | 50 | 50 | 350 | 2.50 |
| Example 25 | Bal. | — | 0.65 | 0.0100 | 0.0500 | 50 | 100 | 100 | 50 | 350 | 1.33 |
| Example 26 | Bal. | — | 0.65 | 0.0100 | 0.0600 | 300 | 0 | 300 | 300 | 1200 | 1.00 |
| Example 27 | Bal. | — | 0.65 | 0.0100 | 0.0500 | 200 | 300 | 250 | 250 | 1200 | 1.40 |
| Example 28 | Bal. | — | 0.65 | 0.0100 | 0.0500 | 100 | 500 | 250 | 250 | 1200 | 1.40 |
| Example 29 | Bal. | — | 0.65 | 0.0100 | 0.0500 | 200 | 50 | 600 | 850 | 1900 | 0.31 |
| Example 30 | Bal. | — | 0.65 | 0.0100 | 0.0500 | 200 | 500 | 1000 | 0 | 1900 | 0.90 |
| Example 31 | Bal. | — | 0.65 | 0.0100 | 0.0500 | 200 | 500 | 1000 | 0 | 1900 | 0.90 |
| Example 32 | Bal. | — | 0.65 | 0.0100 | 0.0500 | 200 | 500 | 0 | 1000 | 1900 | 0.90 |
| Example 33 | Bal. | — | 0.65 | 0.0100 | 0.0500 | 25 | 500 | 350 | 1000 | 1900 | 0.41 |
| Example 34 | Bal. | — | 0.65 | 0.0100 | 0.0350 | 100 | 3000 | 300 | 300 | 3800 | 5.33 |
| Example 35 | Bal. | — | 0.65 | 0.0100 | 0.0500 | 100 | 0 | 0 | 5100 | 5300 | 0.04 |
| Example 36 | Bal. | — | 0.65 | 0.0100 | 0.0500 | 100 | 0 | 10000 | 0 | 10200 | 0.02 |
| Example 37 | Bal. | — | 0.65 | 0.0100 | 0.0500 | 100 | 0 | 10000 | 5000 | 15200 | 0.01 |
| Comparative | Bal. | — | 0.65 | 0.0100 | 0.0500 | 0 | 100 | 100 | 100 | 300 | 0.50 |
| Example 7 | | | | | | | | | | | |
| Comparative | Bal. | — | 0.65 | 0.0100 | 0.0500 | 25 | 25 | 25 | 25 | 125 | 1.50 |
| Example 8 | | | | | | | | | | | |
| Comparative | Bal. | — | 0.65 | 0.0100 | 0.0500 | 300 | 500 | 50 | 50 | 1200 | 11.00 |
| Example 9 | | | | | | | | | | | |
| Comparative | Bal. | — | 0.65 | 0.0100 | 0.0500 | 350 | 1150 | 25 | 25 | 1900 | 37.00 |
| Example 10 | | | | | | | | | | | |
| Comparative | Bal. | — | 0.65 | 0.0100 | 0.0500 | 800 | 800 | 100 | 100 | 2600 | 12.00 |
| Example 11 | | | | | | | | | | | |
| Comparative | Bal. | — | 0.65 | 0.0100 | 0.0500 | 250 | 4800 | 1 | 0 | 5301 | 5300.00 |
| Example 12 | | | | | | | | | | | |
| Comparative | Bal. | — | 0.65 | 0.0100 | 0.0500 | 800 | 3500 | 100 | 100 | 5300 | 25.50 |
| Example 13 | | | | | | | | | | | |
| Comparative | Bal. | — | 0.65 | 0.0100 | 0.0500 | 100 | 10000 | 1 | 0 | 10201 | 10200.00 |
| Example 14 | | | | | | | | | | | |
| Comparative | Bal. | — | 0.65 | 0.0100 | 0.0500 | 100 | 100 | 25000 | 25000 | 50300 | 0.006 |
| Example 15 | | | | | | | | | | | |
| Comparative | Bal. | — | 0.65 | 0.0100 | 0.0500 | 100 | 100 | 70000 | 0 | 70300 | 0.00429 |
| Example 16 | | | | | | | | | | | |
| Comparative | Bal. | — | 0.65 | 0.0100 | 0.0500 | 100 | 100 | 0 | 50000 | 50300 | 0.006 |
| Example 17 | | | | | | | | | | | |
| Comparative | Bal. | — | 0.65 | 0.0100 | 0.0500 | 300 | 3000 | 0 | 0 | 3600 | — |
| Example 18 | | | | | | | | | | | |
| Comparative | Bal. | — | 0.65 | 0.0100 | 0.0500 | 100 | 0 | 100 | 25000 | 25300 | 0.00797 |
| Example 19 | | | | | | | | | | | |

| | | Inhibition | | | | | |
|---|---|---|---|---|---|---|---|
| | | of IMC | Inhibition | | | | |
| | | growth with | of Sn—Cu—Ni | | | | |
| | Expression | respect to | formation | Suppression | | Solder | Comprehensive |
| | (3): Cu/Ni | Cu | in bump | of thickening | ΔT | wettability | evaluation |
| Example 20 | 13.00 | ∘ | ∘ | ∘ | ∘ | ∘ | ∘ |
| Example 21 | 13.00 | ∘ | ∘ | ∘ | ∘ | ∘ | ∘ |
| Example 22 | 13.00 | ∘ | ∘ | ∘ | ∘ | ∘ | ∘ |
| Example 23 | 13.00 | ∘ | ∘ | ∘ | ∘ | ∘ | ∘ |
| Example 24 | 13.00 | ∘ | ∘ | ∘ | ∘ | ∘ | ∘ |
| Example 25 | 13.00 | ∘ | ∘ | ∘ | ∘ | ∘ | ∘ |
| Example 26 | 13.00 | ∘ | ∘ | ∘ | ∘ | ∘ | ∘ |
| Example 27 | 13.00 | ∘ | ∘ | ∘ | ∘ | ∘ | ∘ |
| Example 28 | 13.00 | ∘ | ∘ | ∘ | ∘ | ∘ | ∘ |
| Example 29 | 13.00 | ∘ | ∘ | ∘ | ∘ | ∘ | ∘ |
| Example 30 | 13.00 | ∘ | ∘ | ∘ | ∘ | ∘ | ∘ |
| Example 31 | 13.00 | ∘ | ∘ | ∘ | ∘ | ∘ | ∘ |
| Example 32 | 13.00 | ∘ | ∘ | ∘ | ∘ | ∘ | ∘ |
| Example 33 | 13.00 | ∘ | ∘ | ∘ | ∘ | ∘ | ∘ |
| Example 34 | 13.00 | ∘ | ∘ | ∘ | ∘ | ∘ | ∘ |
| Example 35 | 13.00 | ∘ | ∘ | ∘ | ∘ | ∘ | ∘ |
| Example 36 | 13.00 | ∘ | ∘ | ∘ | ∘ | ∘ | ∘ |
| Example 37 | 13.00 | ∘ | ∘ | ∘ | ∘ | ∘ | ∘ |
| Comparative | 13.00 | ∘ | ∘ | x | ∘ | ∘ | x |
| Example 7 | | | | | | | |
| Comparative | 13.00 | ∘ | ∘ | x | ∘ | ∘ | x |
| Example 8 | | | | | | | |
| Comparative | 13.00 | ∘ | ∘ | ∘ | ∘ | x | x |
| Example 9 | | | | | | | |
| Comparative | 13.00 | ∘ | ∘ | ∘ | ∘ | x | x |
| Example 10 | | | | | | | |
| Comparative | 13.00 | ∘ | ∘ | ∘ | ∘ | x | x |
| Example 11 | | | | | | | |
| Comparative | 13.00 | ∘ | ∘ | ∘ | ∘ | x | x |
| Example 12 | | | | | | | |
| Comparative | 13.00 | ∘ | ∘ | ∘ | ∘ | x | x |
| Example 13 | | | | | | | |
| Comparative | 13.00 | ∘ | ∘ | ∘ | ∘ | x | x |
| Example 14 | | | | | | | |
| Comparative | 13.00 | ∘ | ∘ | ∘ | x | ∘ | x |
| Example 15 | | | | | | | |
| Comparative | 13.00 | ∘ | ∘ | ∘ | x | ∘ | x |
| Example 16 | | | | | | | |
| Comparative | 13.00 | ∘ | ∘ | ∘ | x | ∘ | x |
| Example 17 | | | | | | | |
| Comparative | 13.00 | ∘ | ∘ | ∘ | ∘ | x | x |
| Example 18 | | | | | | | |
| Comparative | 13.00 | ∘ | ∘ | ∘ | x | ∘ | x |
| Example 19 | | | | | | | |

The underlines indicate that the numerical values are out of the ranges of the present invention.

TABLE 3

| | Alloy composition (mass % for Ag, Cu, Ge, and Ni | | | | | | | | | Expression | Expression | |
|---|---|---|---|---|---|---|---|---|---|---|---|---|
| | and mass ppm for As, Sb, Bi, and Pb) | | | | | | | | | (1): 2As + | (2): (2As + | Expression |
| | Sn | Ag | Cu | Ge | Ni | As | Sb | Bi | Pb | Sb + Bi + Pb | Sb)/(Bi + Pb) | (3): Cu/Ni |
| Example 38 | Bal. | — | 0.70 | 0.0080 | 0.0500 | 100 | 25 | 25 | 25 | 275 | 4.50 | 14.00 |
| Example 39 | Bal. | — | 0.75 | 0.0080 | 0.0500 | 100 | 25 | 25 | 25 | 275 | 4.50 | 15.00 |
| Example 40 | Bal. | — | 0.65 | 0.0150 | 0.0350 | 100 | 25 | 25 | 25 | 275 | 4.50 | 18.57 |
| Example 41 | Bal. | — | 0.65 | 0.0080 | 0.0550 | 100 | 25 | 25 | 25 | 275 | 4.50 | 11.82 |
| Example 42 | Bal. | — | 0.65 | 0.0080 | 0.0600 | 100 | 25 | 25 | 25 | 275 | 4.50 | 10.83 |
| Example 43 | Bal. | — | 0.65 | 0.0035 | 0.0500 | 100 | 25 | 25 | 25 | 275 | 4.50 | 13.00 |
| Example 44 | Bal. | — | 0.65 | 0.0050 | 0.0500 | 100 | 25 | 25 | 25 | 275 | 4.50 | 13.00 |
| Example 45 | Bal. | — | 0.65 | 0.0100 | 0.0500 | 100 | 25 | 25 | 25 | 275 | 4.50 | 13.00 |
| Example 46 | Bal. | — | 0.65 | 0.0120 | 0.0500 | 100 | 25 | 25 | 25 | 275 | 4.50 | 13.00 |
| Example 47 | Bal. | — | 0.65 | 0.0200 | 0.0500 | 100 | 25 | 25 | 25 | 275 | 4.50 | 13.00 |
| Example 48 | Bal. | — | 0.65 | 0.0040 | 0.0500 | 100 | 25 | 25 | 25 | 275 | 4.50 | 13.00 |
| Example 49 | Bal. | — | 0.65 | 0.0080 | 0.0500 | 100 | 25 | 25 | 25 | 275 | 4.50 | 13.00 |
| Example 50 | Bal. | — | 0.65 | 0.0080 | 0.0350 | 100 | 25 | 25 | 25 | 275 | 4.50 | 18.57 |
| Example 51 | Bal. | 1.0 | 0.65 | 0.0080 | 0.0500 | 100 | 25 | 25 | 25 | 275 | 4.50 | 13.00 |
| Example 52 | Bal. | 2.0 | 0.65 | 0.0080 | 0.0500 | 100 | 25 | 25 | 25 | 275 | 4.50 | 13.00 |
| Example 53 | Bal. | 3.0 | 0.65 | 0.0080 | 0.0500 | 100 | 25 | 25 | 25 | 275 | 4.50 | 13.00 |
| Example 54 | Bal. | 4.0 | 0.65 | 0.0080 | 0.0500 | 100 | 25 | 25 | 25 | 275 | 4.50 | 13.00 |

| | Inhibition | | | | | |
|---|---|---|---|---|---|---|
| | of IMC | Inhibition | | | | |
| | growth with | of Sn—Cu—Ni | | | | |
| | respect to | formation | Suppression | | Solder | Comprehensive |
| | Cu | in bump | of thickening | ΔT | wettability | evaluation |
| Example 38 | ∘ | ∘ | ∘ | ∘ | ∘ | ∘ |
| Example 39 | ∘ | ∘ | ∘ | ∘ | ∘ | ∘ |
| Example 40 | ∘ | ∘ | ∘ | ∘ | ∘ | ∘ |
| Example 41 | ∘ | ∘ | ∘ | ∘ | ∘ | ∘ |
| Example 42 | ∘ | ∘ | ∘ | ∘ | ∘ | ∘ |
| Example 43 | ∘ | ∘ | ∘ | ∘ | ∘ | ∘ |
| Example 44 | ∘ | ∘ | ∘ | ∘ | ∘ | ∘ |
| Example 45 | ∘ | ∘ | ∘ | ∘ | ∘ | ∘ |
| Example 46 | ∘ | ∘ | ∘ | ∘ | ∘ | ∘ |
| Example 47 | ∘ | ∘ | ∘ | ∘ | ∘ | ∘ |
| Example 48 | ∘ | ∘ | ∘ | ∘ | ∘ | ∘ |
| Example 49 | ∘ | ∘ | ∘ | ∘ | ∘ | ∘ |
| Example 50 | ∘ | ∘ | ∘ | ∘ | ∘ | ∘ |
| Example 51 | ∘ | ∘ | ∘ | ∘ | ∘ | ∘ |
| Example 52 | ∘ | ∘ | ∘ | ∘ | ∘ | ∘ |
| Example 53 | ∘ | ∘ | ∘ | ∘ | ∘ | ∘ |
| Example 54 | ∘ | ∘ | ∘ | ∘ | ∘ | ∘ |

TABLE 4

| | Alloy composition (mass % for Ag, Cu, Ge, and Ni | | | | | | | | | Expression | Expression | |
|---|---|---|---|---|---|---|---|---|---|---|---|---|
| | and mass ppm for As, Sb, Bi, and Pb) | | | | | | | | | (1): 2As + | (2): (2As + | Expression |
| | Sn | Ag | Cu | Ge | Ni | As | Sb | Bi | Pb | Sb + Bi + Pb | Sb)/(Bi + Pb) | (3): Cu/Ni |
| Example 55 | Bal. | — | 0.70 | 0.0080 | 0.0500 | 100 | 50 | 25 | 1 | 276 | 9.62 | 14.00 |
| Example 56 | Bal. | — | 0.75 | 0.0080 | 0.0500 | 100 | 50 | 25 | 1 | 276 | 9.62 | 15.00 |
| Example 57 | Bal. | — | 0.65 | 0.0150 | 0.0350 | 100 | 50 | 25 | 1 | 276 | 9.62 | 18.57 |
| Example 58 | Bal. | — | 0.65 | 0.0080 | 0.0550 | 100 | 50 | 25 | 1 | 276 | 9.62 | 11.82 |
| Example 59 | Bal. | — | 0.65 | 0.0080 | 0.0600 | 100 | 50 | 25 | 1 | 276 | 9.62 | 10.83 |
| Example 60 | Bal. | — | 0.65 | 0.0035 | 0.0500 | 100 | 50 | 25 | 1 | 276 | 9.62 | 13.00 |
| Example 61 | Bal. | — | 0.65 | 0.0050 | 0.0500 | 100 | 50 | 25 | 1 | 276 | 9.62 | 13.00 |
| Example 62 | Bal. | — | 0.65 | 0.0100 | 0.0500 | 100 | 50 | 25 | 1 | 276 | 9.62 | 13.00 |
| Example 63 | Bal. | — | 0.65 | 0.0120 | 0.0500 | 100 | 50 | 25 | 1 | 276 | 9.62 | 13.00 |
| Example 64 | Bal. | — | 0.65 | 0.0200 | 0.0500 | 100 | 50 | 25 | 1 | 276 | 9.62 | 13.00 |
| Example 65 | Bal. | — | 0.65 | 0.0040 | 0.0500 | 100 | 50 | 25 | 1 | 276 | 9.62 | 13.00 |
| Example 66 | Bal. | — | 0.65 | 0.0080 | 0.0500 | 100 | 50 | 25 | 1 | 276 | 9.62 | 13.00 |
| Example 67 | Bal. | — | 0.65 | 0.0080 | 0.0350 | 100 | 50 | 25 | 1 | 276 | 9.62 | 18.57 |
| Example 68 | Bal. | 1.0 | 0.65 | 0.0080 | 0.0500 | 100 | 50 | 25 | 1 | 276 | 9.62 | 13.00 |
| Example 69 | Bal. | 2.0 | 0.65 | 0.0080 | 0.0500 | 100 | 50 | 25 | 1 | 276 | 9.62 | 13.00 |
| Example 70 | Bal. | 3.0 | 0.65 | 0.0080 | 0.0500 | 100 | 50 | 25 | 1 | 276 | 9.62 | 13.00 |
| Example 71 | Bal. | 4.0 | 0.65 | 0.0080 | 0.0500 | 100 | 50 | 25 | 1 | 276 | 9.62 | 13.00 |

| | Inhibition | | | | | |
|---|---|---|---|---|---|---|
| | of IMC | Inhibition | | | | |
| | growth with | of Sn—Cu—Ni | | | | |
| | respect to | formation | Suppression | | Solder | Comprehensive |
| | Cu | in bump | of thickening | ΔT | wettability | evaluation |
| Example 55 | ∘ | ∘ | ∘ | ∘ | ∘ | ∘ |
| Example 56 | ∘ | ∘ | ∘ | ∘ | ∘ | ∘ |
| Example 57 | ∘ | ∘ | ∘ | ∘ | ∘ | ∘ |
| Example 58 | ∘ | ∘ | ∘ | ∘ | ∘ | ∘ |
| Example 59 | ∘ | ∘ | ∘ | ∘ | ∘ | ∘ |
| Example 60 | ∘ | ∘ | ∘ | ∘ | ∘ | ∘ |
| Example 61 | ∘ | ∘ | ∘ | ∘ | ∘ | ∘ |
| Example 62 | ∘ | ∘ | ∘ | ∘ | ∘ | ∘ |
| Example 63 | ∘ | ∘ | ∘ | ∘ | ∘ | ∘ |
| Example 64 | ∘ | ∘ | ∘ | ∘ | ∘ | ∘ |
| Example 65 | ∘ | ∘ | ∘ | ∘ | ∘ | ∘ |
| Example 66 | ∘ | ∘ | ∘ | ∘ | ∘ | ∘ |
| Example 67 | ∘ | ∘ | ∘ | ∘ | ∘ | ∘ |
| Example 68 | ∘ | ∘ | ∘ | ∘ | ∘ | ∘ |
| Example 69 | ∘ | ∘ | ∘ | ∘ | ∘ | ∘ |
| Example 70 | ∘ | ∘ | ∘ | ∘ | ∘ | ∘ |
| Example 71 | ∘ | ∘ | ∘ | ∘ | ∘ | ∘ |

TABLE 5

| | Alloy composition (mass % for Ag, Cu, Ge, and Ni | | | | | | | | | Expression | Expression |
|---|---|---|---|---|---|---|---|---|---|---|---|
| | and mass ppm for As, Sb, Bi, and Pb) | | | | | | | | | (1): 2As + | (2): (2As + |
| | Sn | Ag | Cu | Ge | Ni | As | Sb | Bi | Pb | Sb + Bi + Pb | Sb)/(Bi + Pb) |
| Example 72 | Bal. | — | 0.70 | 0.0080 | 0.0500 | 100 | 10 | 10000 | 10 | 10220 | 0.02 |
| Example 73 | Bal. | — | 0.75 | 0.0080 | 0.0500 | 100 | 10 | 10000 | 10 | 10220 | 0.02 |
| Example 74 | Bal. | — | 0.65 | 0.0150 | 0.0350 | 100 | 10 | 10000 | 10 | 10220 | 0.02 |
| Example 75 | Bal. | — | 0.65 | 0.0080 | 0.0550 | 100 | 10 | 10000 | 10 | 10220 | 0.02 |
| Example 76 | Bal. | — | 0.65 | 0.0080 | 0.0600 | 100 | 10 | 10000 | 10 | 10220 | 0.02 |
| Example 77 | Bal. | — | 0.65 | 0.0035 | 0.0500 | 100 | 10 | 10000 | 10 | 10220 | 0.02 |
| Example 78 | Bal. | — | 0.65 | 0.0050 | 0.0500 | 100 | 10 | 10000 | 10 | 10220 | 0.02 |
| Example 79 | Bal. | — | 0.65 | 0.0100 | 0.0500 | 100 | 10 | 10000 | 10 | 10220 | 0.02 |
| Example 80 | Bal. | — | 0.65 | 0.0120 | 0.0500 | 100 | 10 | 10000 | 10 | 10220 | 0.02 |
| Example 81 | Bal. | — | 0.65 | 0.0200 | 0.0500 | 100 | 10 | 10000 | 10 | 10220 | 0.02 |
| Example 82 | Bal. | — | 0.65 | 0.0040 | 0.0500 | 100 | 10 | 10000 | 10 | 10220 | 0.02 |
| Example 83 | Bal. | — | 0.65 | 0.0080 | 0.0500 | 100 | 10 | 10000 | 10 | 10220 | 0.02 |
| Example 84 | Bal. | — | 0.65 | 0.0080 | 0.0350 | 100 | 10 | 10000 | 10 | 10220 | 0.02 |
| Example 85 | Bal. | 1.0 | 0.65 | 0.0080 | 0.0500 | 100 | 10 | 10000 | 10 | 10220 | 0.02 |
| Example 86 | Bal. | 2.0 | 0.65 | 0.0080 | 0.0500 | 100 | 10 | 10000 | 10 | 10220 | 0.02 |
| Example 87 | Bal. | 3.0 | 0.65 | 0.0080 | 0.0500 | 100 | 10 | 10000 | 10 | 10220 | 0.02 |
| Example 88 | Bal. | 4.0 | 0.65 | 0.0080 | 0.0500 | 100 | 10 | 10000 | 10 | 10220 | 0.02 |

| | | Inhibition | | | | | |
|---|---|---|---|---|---|---|---|
| | | of IMC | Inhibition | | | | |
| | | growth with | of Sn—Cu—Ni | | | | |
| | Expression | respect to | formation in | Suppression | | Solder | Comprehensive |
| | (3): Cu/Ni | Cu | bump | of thickening | ΔT | wettability | evaluation |
| Example 72 | 14.00 | ∘ | ∘ | ∘ | ∘ | ∘ | ∘ |
| Example 73 | 15.00 | ∘ | ∘ | ∘ | ∘ | ∘ | ∘ |
| Example 74 | 18.57 | ∘ | ∘ | ∘ | ∘ | ∘ | ∘ |
| Example 75 | 11.82 | ∘ | ∘ | ∘ | ∘ | ∘ | ∘ |
| Example 76 | 10.83 | ∘ | ∘ | ∘ | ∘ | ∘ | ∘ |
| Example 77 | 13.00 | ∘ | ∘ | ∘ | ∘ | ∘ | ∘ |
| Example 78 | 13.00 | ∘ | ∘ | ∘ | ∘ | ∘ | ∘ |
| Example 79 | 13.00 | ∘ | ∘ | ∘ | ∘ | ∘ | ∘ |
| Example 80 | 13.00 | ∘ | ∘ | ∘ | ∘ | ∘ | ∘ |
| Example 81 | 13.00 | ∘ | ∘ | ∘ | ∘ | ∘ | ∘ |
| Example 82 | 13.00 | ∘ | ∘ | ∘ | ∘ | ∘ | ∘ |
| Example 83 | 13.00 | ∘ | ∘ | ∘ | ∘ | ∘ | ∘ |
| Example 84 | 18.57 | ∘ | ∘ | ∘ | ∘ | ∘ | ∘ |
| Example 85 | 13.00 | ∘ | ∘ | ∘ | ∘ | ∘ | ∘ |
| Example 86 | 13.00 | ∘ | ∘ | ∘ | ∘ | ∘ | ∘ |
| Example 87 | 13.00 | ∘ | ∘ | ∘ | ∘ | ∘ | ∘ |
| Example 88 | 13.00 | ∘ | ∘ | ∘ | ∘ | ∘ | ∘ |

TABLE 6

| | Alloy composition (mass % for Ag, Cu, Ge, and Ni | | | | | | | | | Expression | Expression |
|---|---|---|---|---|---|---|---|---|---|---|---|
| | and mass ppm for As, Sb, Bi, and Pb) | | | | | | | | | (1): 2As + | (2): (2As + |
| | Sn | Ag | Cu | Ge | Ni | As | Sb | Bi | Pb | Sb + Bi + Pb | Sb)/(Bi + Pb) |
| Example 89 | Bal. | — | 0.70 | 0.0080 | 0.050 | 100 | 10 | 10000 | 5000 | 15210 | 0.01 |
| Example 90 | Bal. | — | 0.75 | 0.0080 | 0.050 | 100 | 10 | 10000 | 5000 | 15210 | 0.01 |
| Example 91 | Bal. | — | 0.65 | 0.0150 | 0.035 | 100 | 10 | 10000 | 5000 | 15210 | 0.01 |
| Example 92 | Bal. | — | 0.65 | 0.0080 | 0.055 | 100 | 10 | 10000 | 5000 | 15210 | 0.01 |
| Example 93 | Bal. | — | 0.65 | 0.0080 | 0.060 | 100 | 10 | 10000 | 5000 | 15210 | 0.01 |
| Example 94 | Bal. | — | 0.65 | 0.0035 | 0.050 | 100 | 10 | 10000 | 5000 | 15210 | 0.01 |
| Example 95 | Bal. | — | 0.65 | 0.0050 | 0.050 | 100 | 10 | 10000 | 5000 | 15210 | 0.01 |
| Example 96 | Bal. | — | 0.65 | 0.0100 | 0.050 | 100 | 10 | 10000 | 5000 | 15210 | 0.01 |
| Example 97 | Bal. | — | 0.65 | 0.0120 | 0.050 | 100 | 10 | 10000 | 5000 | 15210 | 0.01 |
| Example 98 | Bal. | — | 0.65 | 0.0200 | 0.050 | 100 | 10 | 10000 | 5000 | 15210 | 0.01 |
| Example 99 | Bal. | — | 0.65 | 0.0040 | 0.050 | 100 | 10 | 10000 | 5000 | 15210 | 0.01 |
| Example 100 | Bal. | — | 0.65 | 0.0080 | 0.050 | 100 | 10 | 10000 | 5000 | 15210 | 0.01 |
| Example 101 | Bal. | — | 0.65 | 0.0080 | 0.035 | 100 | 10 | 10000 | 5000 | 15210 | 0.01 |
| Example 102 | Bal. | 1.0 | 0.65 | 0.0080 | 0.050 | 100 | 10 | 10000 | 5000 | 15210 | 0.01 |
| Example 103 | Bal. | 2.0 | 0.65 | 0.0080 | 0.050 | 100 | 10 | 10000 | 5000 | 15210 | 0.01 |
| Example 104 | Bal. | 3.0 | 0.65 | 0.0080 | 0.050 | 100 | 10 | 10000 | 5000 | 15210 | 0.01 |
| Example 105 | Bal. | 4.0 | 0.65 | 0.0080 | 0.050 | 100 | 10 | 10000 | 5000 | 15210 | 0.01 |

| | | Inhibition | | | | | |
|---|---|---|---|---|---|---|---|
| | | of IMC | Inhibition | | | | |
| | | growth with | of Sn—Cu—Ni | | | | |
| | Expression | respect to | formation in | Suppression | | Solder | Comprehensive |
| | (3): Cu/Ni | Cu | bump | of thickening | ΔT | wettability | evaluation |
| Example 89 | 14.00 | ∘ | ∘ | ∘ | ∘ | ∘ | ∘ |
| Example 90 | 15.00 | ∘ | ∘ | ∘ | ∘ | ∘ | ∘ |
| Example 91 | 18.57 | ∘ | ∘ | ∘ | ∘ | ∘ | ∘ |
| Example 92 | 11.82 | ∘ | ∘ | ∘ | ∘ | ∘ | ∘ |
| Example 93 | 10.83 | ∘ | ∘ | ∘ | ∘ | ∘ | ∘ |
| Example 94 | 13.00 | ∘ | ∘ | ∘ | ∘ | ∘ | ∘ |
| Example 95 | 13.00 | ∘ | ∘ | ∘ | ∘ | ∘ | ∘ |
| Example 96 | 13.00 | ∘ | ∘ | ∘ | ∘ | ∘ | ∘ |
| Example 97 | 13.00 | ∘ | ∘ | ∘ | ∘ | ∘ | ∘ |
| Example 98 | 13.00 | ∘ | ∘ | ∘ | ∘ | ∘ | ∘ |
| Example 99 | 13.00 | ∘ | ∘ | ∘ | ∘ | ∘ | ∘ |
| Example 100 | 13.00 | ∘ | ∘ | ∘ | ∘ | ∘ | ∘ |
| Example 101 | 18.57 | ∘ | ∘ | ∘ | ∘ | ∘ | ∘ |
| Example 102 | 13.00 | ∘ | ∘ | ∘ | ∘ | ∘ | ∘ |
| Example 103 | 13.00 | ∘ | ∘ | ∘ | ∘ | ∘ | ∘ |
| Example 104 | 13.00 | ∘ | ∘ | ∘ | ∘ | ∘ | ∘ |
| Example 105 | 13.00 | ∘ | ∘ | ∘ | ∘ | ∘ | ∘ |

Since Examples 1 to 105 satisfied all the requirements of the present invention with any alloy composition as shown in Tables 1 to 6, it was found that the inhibition of IMC growth with respect to Cu, the inhibition of the Sn—Cu—Ni formation in a bump, the thickening suppression effect, the narrowing of ΔT, and the excellent solder wettability were exhibited at the same time. On the other hand, since Comparative Examples 1 to 19 did not satisfy at least one of the requirements of the present invention with all of the alloy compositions, it was found that at least one of these deteriorated.

1. A solder alloy which has an alloy composition containing 0.55 to 0.75 mass % of Cu, 0.0350 to 0.0600 mass % of Ni, 0.0035 to 0.0200 mass % of Ge, and 25 to 300 mass ppm of As, at least either one of 0 to 3000 mass ppm of Sb, 0 to 10000 mass ppm of Bi, and 0 to 5100 mass ppm of Pb, and a balance of Sn, and satisfies Expressions (1) to (3) below
275≤2As+Sb+Bi+Pb (1)
0.01≤(2As+Sb)/(Bi+Pb)≤10.00 (2)
10.83≤Cu/Ni≤18.57 (3)
in Expressions (1) to (3) shown above, Cu, Ni, As, Sb, Bi, and Pb each represent an amount (mass ppm) in the alloy composition.

2. The solder alloy according to claim 1,
wherein the alloy composition further satisfies Expression (1a) below
275≤2As+Sb+Bi+Pb≤25200 (1a)
in Expression (1a) shown above, As, Sb, Bi, and Pb each represent an amount (mass ppm) in the alloy composition.

3. The solder alloy according to claim 1,
wherein the alloy composition further satisfies Expression (1b) below
275≤2As+Sb+Bi+Pb≤5300 (1b)
in Expression (1b) shown above, As, Sb, Bi, and Pb each represent an amount (mass ppm) in the alloy composition.

4. The solder alloy according to claim 1,
wherein the alloy composition further satisfies Expression (2a) below
0.31≤(2As+Sb)/(Bi+Pb)≤10.00 (2a)
in Expression (2a) shown above, As, Sb, Bi, and Pb each represent an amount (mass ppm) in the alloy composition.

5. The solder alloy according to claim 1,
wherein the alloy composition further contains 0 to 4 mass % of Ag.

6. A solder powder formed of the solder alloy according to claim 1.

7. A solder paste composed of the solder powder according to claim 6 which contains no solder powder other than the solder powder according to claim 6.

8. A solder joint composed of the solder alloy according to claim 1 which contains no solder alloy other than the solder alloy according to claim 1.

9. The solder alloy according to claim 2,
wherein the alloy composition further satisfies Expression (2a) below
0.31≤(2As+Sb)/(Bi+Pb)≤10.00 (2a)
in Expression (2a) shown above, As, Sb, Bi, and Pb each represent an amount (mass ppm) in the alloy composition.

10. The solder alloy according to claim 3,
wherein the alloy composition further satisfies Expression (2a) below
0.31≤(2As+Sb)/(Bi+Pb)≤10.00 (2a)
in Expression (2a) shown above, As, Sb, Bi, and Pb each represent an amount (mass ppm) in the alloy composition.

11. The solder alloy according to claim 2,
wherein the alloy composition further contains 0 to 4 mass % of Ag.

12. The solder alloy according to claim 3,
wherein the alloy composition further contains 0 to 4 mass % of Ag.

13. The solder alloy according to claim 4,
wherein the alloy composition further contains 0 to 4 mass % of Ag.

14. The solder alloy according to claim 9,
wherein the alloy composition further contains 0 to 4 mass % of Ag.

15. The solder alloy according to claim 10,
wherein the alloy composition further contains 0 to 4 mass % of Ag.
